(19) United States
(12) Patent Application Publication
(10) Pub. No.: US 2013/0262464 A1
(43) Pub. Date: Oct. 3, 2013

(54) System Configuration Method And Apparatus

(71) Applicant: B.L. KLANE HOLDINGS L.L.C., Syracuse, NY (US)

(72) Inventors: Barnett Klane, Syracuse, NY (US); Adam LaFave, San Francisco, CA (US); Herb Sussman, Geneseo, NY (US)

(21) Appl. No.: 13/852,432

(22) Filed: Mar. 28, 2013

Related U.S. Application Data
(60) Provisional application No. 61/617,089, filed on Mar. 29, 2012.
(60) Provisional application No. 61/635,898, filed on Apr. 20, 2012.
(60) Provisional application No. 61/737,464, filed on Dec. 14, 2012.

(51) Int. Cl. G06F 17/30

(52) U.S. Cl. CPC G06F 17/30312
USPC 707/736

(57) ABSTRACT

Systems and methods of simplifying the configuration of systems, particularly those with components from multiple vendors are disclosed. In one embodiment, the system allows a user to enter the identity of the components that are to be assembled. Based on this, a rules-based logic system in conjunction with a database, generates a customized set of installation instructions for these particular components. These step-by-step instructions are then delivered to the user using a data output system. In some embodiments, the instructions are accompanied by images, illustrations or photographs of the component being described. The data input may be performed in a number of ways. In one embodiment, each component that is included in the database is labeled with an RFID tag which uniquely identifies it. In other embodiments, a bar code, the manufacturing SKU, a QR code, or an identifier from the retailer's receipt provides the identification information.

This application claims priority of U.S. Provisional Patent Application Ser. Nos. 61/617,089, filed Mar. 29, 2012; 61/635,898, filed Apr. 20, 2012; and 61/737,464, filed Dec. 14, 2012, the disclosures of which are incorporated herein by reference in their entities.

### BACKGROUND

In today's marketplace, consumers have the ability to purchase components from a variety of suppliers. The large number of suppliers causes increased level of competition between vendors. This competition typically results in lower prices and increased feature sets in these components.

However, the variety of components also has drawbacks. For example, in certain applications, a number of components must be connected together to form a functional system. Examples of these types of systems include sound systems, multi-media home theater systems, lighting systems and others. A consumer may buy a television from one supplier, a DVD player from a second supplier, a mixer and amplifier from another supplier, and a speaker system from yet another supplier. Unfortunately, since the components come from different suppliers, there is no installation manual on how best to assemble or configure these components together. In some cases, consumers attempt to configure these components themselves, often times not optimizing the system or not enabling all of the functionality available in the system. As a result, consulting businesses and installation services from retailer stores have emerged to help consumers configure these multi-vendor systems. In most cases, these services require one or more experts visit the consumer's home and physically assemble the components together, thereby requiring the consumer to pay additional money for this service.

It would be advantageous if there were a system and method to allow a consumer to configure their own system, without the need for an expert to perform the installation. For example, if a customized set of instructions, complete with illustrations were available, the configuration and installation procedure could be performed by a typical consumer. Since customer satisfaction issues resulting from installation problems would be reduced, this proves beneficial to the supplier as well as the consumer.

### SUMMARY

Systems and methods of simplifying the configuration of systems, particularly those with components from multiple vendors are disclosed. In one embodiment, the system allows a user to enter the identity of the components that are to be assembled. Based on this, a rules-based logic system, in conjunction with a database, generates a customized set of installation instructions for these particular components. These step-by-step instructions are then delivered to the user using a data output system. In some embodiments, the instructions are accompanied by illustrations or photographs of the component being described. The data input may be performed in a number of ways. In one embodiment, each component that is included in the database is labeled with an RFID tag that uniquely identifies it. In other embodiments, a bar code, the manufacturing SKU, a QR code, or an identifier from the retailer's receipt provides the identification information.

### BRIEF DESCRIPTION OF FIGURES

FIG. 1 shows the process of verifying all components according to one embodiment;

FIG. 2 is a schematic representation of the system used in some embodiments;

FIG. 3 is a flowchart showing the generation of instructions according to one embodiment;

FIG. 4 shows an error message according to one embodiment;

FIG. 5 shows an instruction according to one embodiment;

FIG. 6 shows an expanded view of the instruction of FIG. 5;

FIG. 7 shows a list of instructions according to one embodiment; and

FIG. 8 shows a list of components entered by the user.

### DETAILED DESCRIPTION

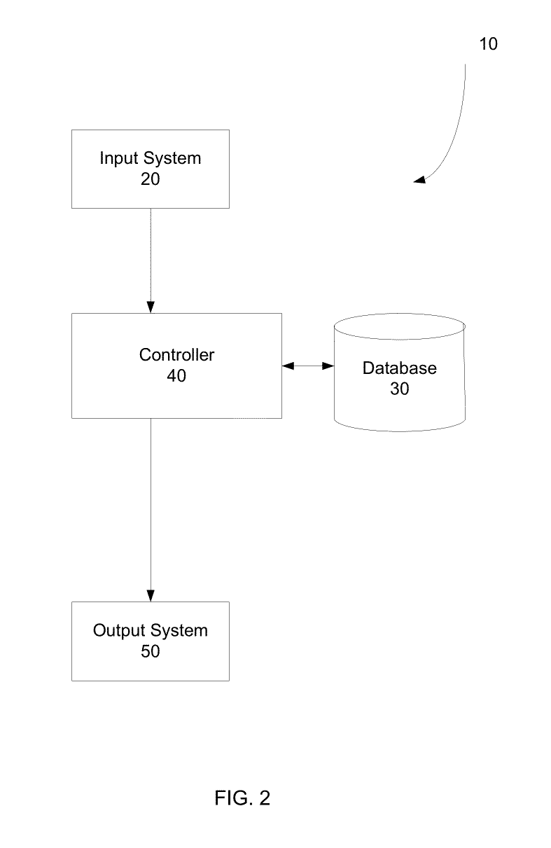

The system of the present invention, shown in FIG. 2, includes a system 10 having a data input system 20, a database 30, a controller 40, which may be a rules-based logic system and a data output system 50. The controller 40 may be a processing unit, such as a general purpose computer, an embedded processor, such as those found in mobile devices, or a specialized processor. This processing unit may be in communication with a memory element (not shown), which comprises a set of computer executable instructions. These instructions, when executed by the processing unit, enable the system 10 to perform the functions described herein. Throughout this disclosure, the term “software application” may also be used to describe the set of instructions executed by the controller 40. In addition, the terms “controller” and “rules-base logic system” are used interchangeably to depict any computing element that can execute the functions and compatibility checks described herein.

In summary, the system 10 allows a user to enter the identity of the components that are to be assembled. Based on this, the controller 40, using a rules-based logic system, in conjunction with the database 30, generates a customized set of installation instructions. These step-by-step instructions are then delivered to the user using the data output system 50. In some embodiments, the instructions are accompanied by illustrations or photographs of the component being described.

Data input may be performed in a number of ways. In one embodiment, each component that is included in the database 30 is labeled with an RFID tag which uniquely identifies it. In other embodiments, a unique identifier, such as a bar code, the manufacturing SKU, or an identifier from the retailer's receipt provides the identification information. In yet another embodiment, a QR code is applied to each component. Of course, the invention is not limited to any particular method of identifying the component. While several possible methods are disclosed, other methods may also be used.

The input system 20 provides an input device to allow the user to input the components that are intended to be part of the assembled system. Examples of such devices include RFID readers, bar code scanners, other visual scanning mechanisms and keypad entry devices. In some embodiments, such as in the case of QR codes, the user's mobile device, equipped with a camera, may serve as the input device. For example, if QR codes are applied to all of the components, the user may use their mobile phone, with one of the many generic QR readers readily available, to input a component into the present invention.

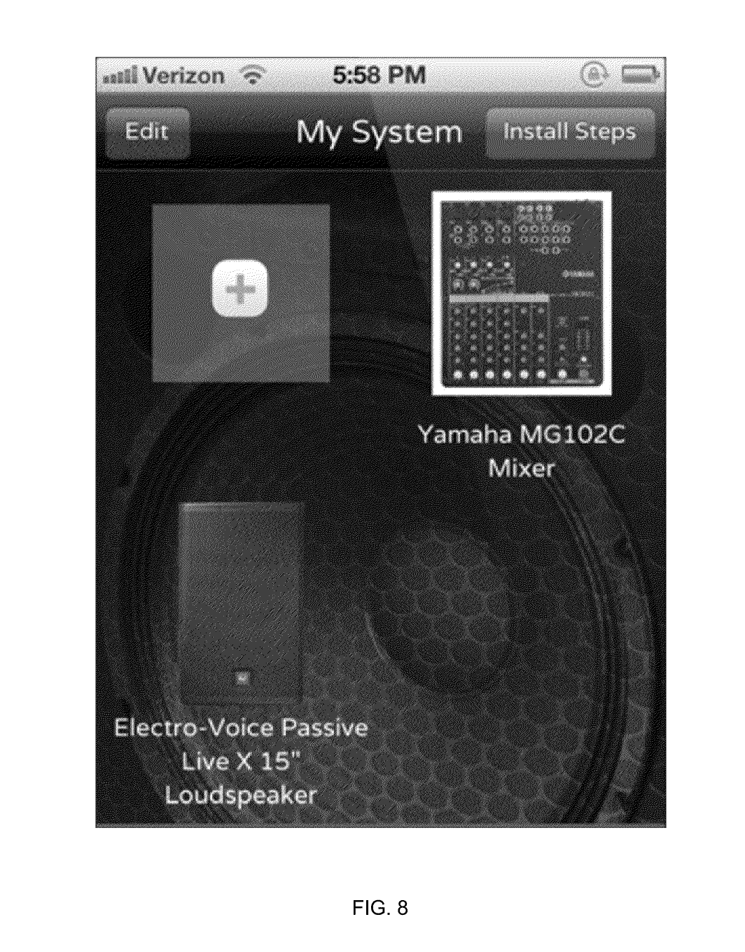

As the user scans the various components using the input system 20, the output system 50 may display the components currently included in the configuration. FIG. 8 shows a display where the user has previously entered two components. The user may then click or other select the add button (depicted as “+”) and scan another component. This new component would then appear on this screen.

The output system 50 may include the display for a mobile device, such as a mobile phone or tablet. In other embodiments, the output system may be a printer, such that the assembled instructions are printed for the user. Other output devices are also possible.

In one embodiment, the present invention may instruct the user to download a mobile software application onto their mobile phone. This mobile software application may be used for inputting the component information and may also be used to display the resultant step-by-step directions. In other words, the user's mobile device may serve as input system 20 and output system 50. In some embodiments, the controller 40 and database 30 may be remotely located and communicate with the input system 20 and the output system 50 via a network connection, such as a wireless or wired connection.

The present invention also has a database 30, containing information about every component supported by the present invention. For example, the database 30 may include information about power requirements, required inputs, required outputs, size of connectors and cables needed to interface to the component, and performance specifications for the component. In some embodiments, the database 30 also contains one or more images of the component. For example, the database 30 may have one or more views of the component showing the various connectors and ports located on the device. The database 30 may store various characteristics, including but not limited to a product's name, its price, its description, its power ratings (ohm ratings, etc), its size, its weight, and other functional specifications.

In one embodiment, the database 30 is preconfigured with certain product groups and attributes, as defined below. For example, these devices in the database 30 may be classified into distinct categories such as active loudspeakers, passive loudspeakers and mixers. This classification also aids in populating the database 30. For example, all power amplifiers have the property ‘amplifier gain’ but no other products do. Other categories may include visual system (i.e. televisions), media systems (i.e. DVD and Blu-Ray® players), and other categories. Attributes may include power output, recommended power inputs, connector types, screen resolution, and others.

In some embodiments, as described above, the product groups and attributes in the database 30 may be predetermined. However, in other embodiments, the database 30 may be completely flexible, allowing the user to generate product groups and attributes, as required by the implementation. In other words, while the present disclosure describes a system for use with audio and visual equipment, the concept can be expanded to cover any type of configuration, by customizing the product groups and attributes that are stored in the database 30.

Using this information in the database 30, the present invention may utilize a rules-based logic system to determine various parameters. For example, there are various checks for compatibility that can be done. These include:
Confirming that two components that are intended to connect together utilize a common cable or connector. For example, a DVD player may have only an HDMI output and the selected television may not have such an input.
In some embodiments, confirming that all of the required cables and connectors are available at the user's location.
Confirming that the output of the first component is within the specified input range of the second component. For example, the output of a particular amplifier may exceed the ratings for a particular set of speakers. In another example, the speakers may be 4 ohm speakers, while the output of the amplifier is intended for 8 ohm speakers.
Confirming that all components required for a configuration are present. For example, passive speakers require a power amplifier, and a power amplifier is recommended to be used with a mixer. Therefore, if passive speakers are part of the user's system, power amplifier must also be present, while a mixer should also be present, but if unavailable will display a warning and continue with configuration.

While several possible compatibility checks are described above, other checks are also possible and within the scope of the disclosure.

If an incompatibility is found, the software may simply terminate, or may provide guidance to the user. In some embodiments, this feedback to the user is provided via the user's mobile device, such as via output system 50. For example, in the last scenario enumerated above, the present invention may send information to the user's mobile device, suggesting the user buy the missing component, and, based on the other components in the user's system, may suggest a particular component best suited to the rest of the system. In some embodiments, the software application may interface with a related or associated on-line website where the missing component may be purchased by the user directly from their mobile device.

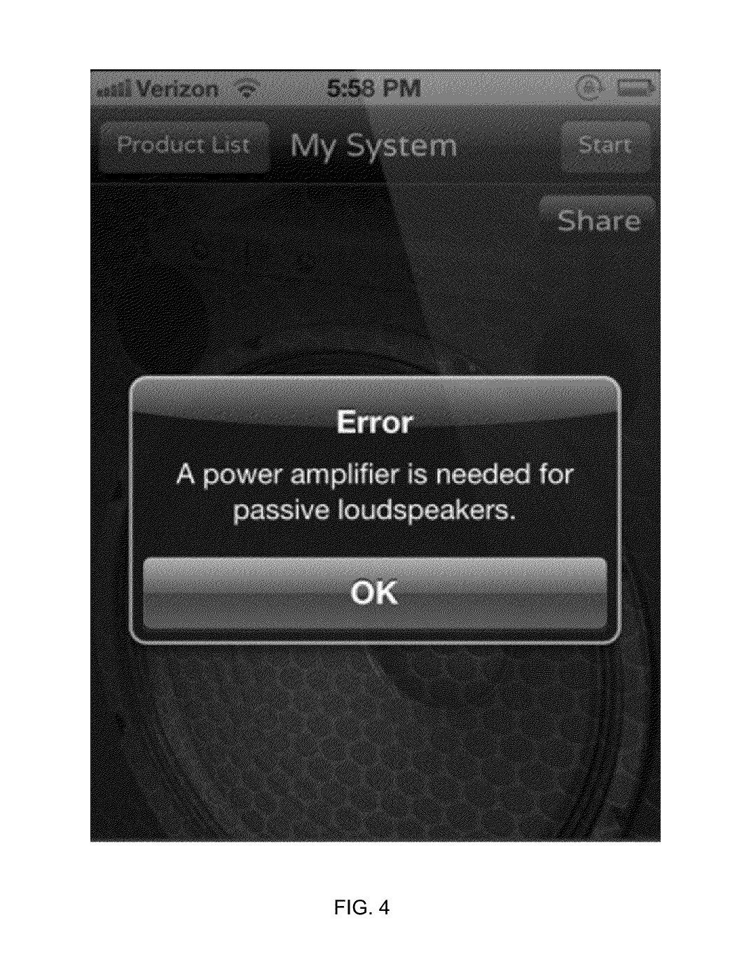

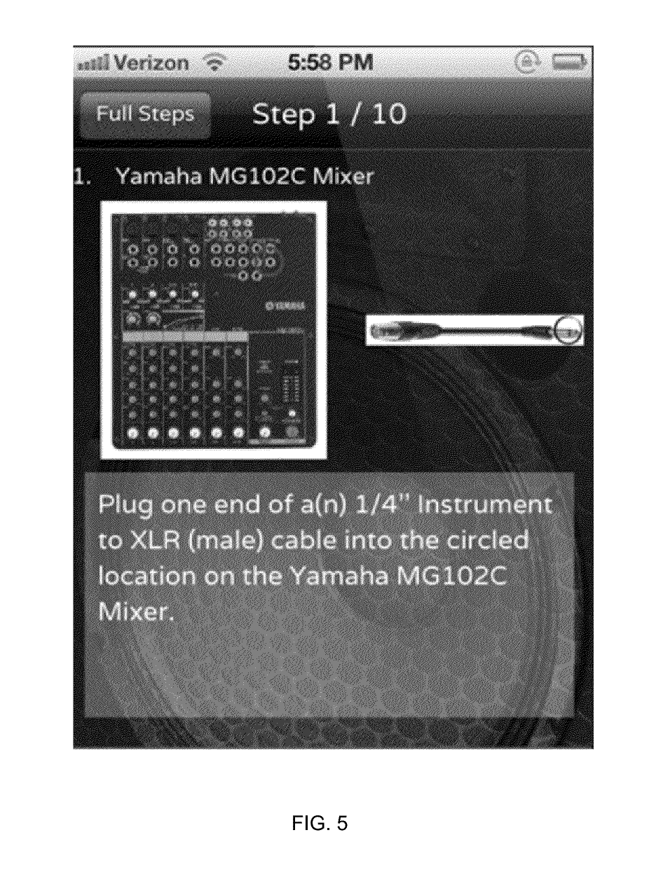

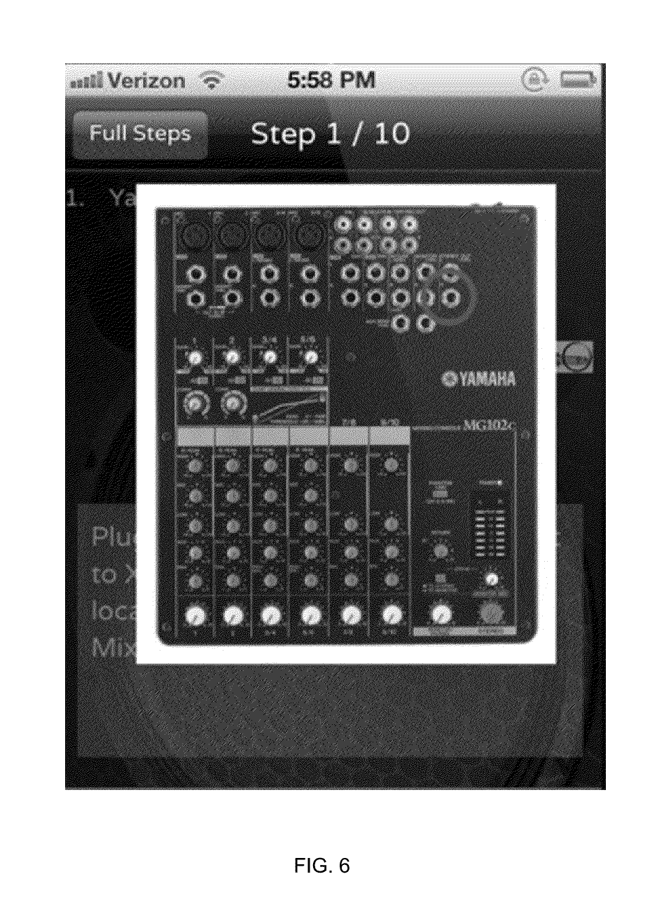

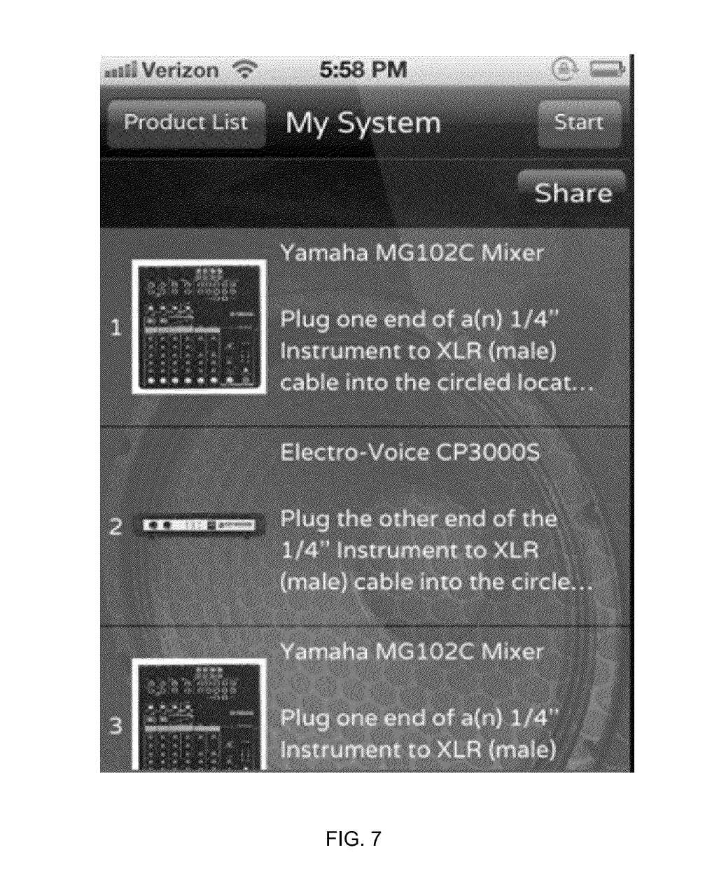

Assuming that all of the components are compatible with each other, the controller 40, using the rules-based logic system, then attempts to assemble the components, using a set of rules. When this is completed, a detailed set of set-up instructions are transmitted back to the mobile device for viewing by the user via the output system 50. Each instruction may provide a picture of the component, a picture of the cable to be used, an indicator showing where the plug is inserted into the component, and a detailed description of the necessary actions for this instruction. For example, FIG. 5 shows an instruction where the user is told to plug a cable into a mixer. In some embodiments, expanded views may be generated. For example, the user may click or other point at the graphic representing the mixer. This may cause the graphic of the mixer to be expanded, as shown in FIG. 6. Error messages, such as those related to configuration errors may also be displayed. One such error message is shown in FIG. 4. Note that the error message of FIG. 4 denotes a specific configuration error. Other error messages that explain other configuration errors may also be generated. Warnings may also be displayed via a pop-up message or dialog box. Warnings may be presented to the user for issues which do not necessarily prevent the operation of the setup but may degrade the system performance. Individual instructions can be viewed in a method similar to swiping through photos or in a list view to quickly skip to a certain instruction step. For example, an instruction may be displayed on the user's mobile device. Using a hand gesture, such as a swipe, the user may cause the next step to be presented. In another embodiment, the instructions are displayed as a list, where each may or may not be identified by a title. An example of this embodiment is shown in FIG. 7. In this case, the user may move directly to a particular instruction step by clicking or otherwise pointing to that step.

Each set of step-by-step instructions is generated dynamically and is unique to the components scanned in by the user. In other words, the instructions are not merely stored, pre-processed, on the server and delivered to the user. Rather, the instruction steps are generated by the controller 40 and passed to the user based on their unique assortment of components. The logic determining the instruction steps can be modified without modifying the rest of the present invention.

In one embodiment, QR codes are placed on some or all of the components. The user then scans all of the QR codes using their mobile phone. Going further into how QR codes store product IDs, each QR code contains a URL, which may end with the product identifier, such as www.amplifyu.co/scan/315. One reason that a URL may be used instead of simply storing the product ID is to enable any QR code scanner to be used to scan the QR code and be redirected to a download page. In some embodiments, the referenced website (i.e. www.amplifyu/scan/315) is actually a landing page redirecting the user to download the app, and perhaps offering more information on the application, as well. In other words, each of the QR codes may serve a dual purpose by providing a product identifier to the present invention and a website URL, which allows the user to download the mobile portion of the software system to their mobile device. This may be achieved by using a wildcard in the URL that will redirect all requests to the same app-download page. For example, two different websites, generated based on two different QR codes, such as amplifyu.co/scan/315 and amplifyu.co/scan/994, will redirect to the same web page to download the application if scanned by a regular QR code scanner. In addition, the present invention will know that the user just scanned two products: one with an id of 315 and one with an id of 994.

Once all of the components have been scanned using input system 20, the information associated with each component is extracted from the database 30. Again, all of the components supported by the present invention will have all of their important characteristics stored in the database 30 to enable the controller 40 or rule-based logic system to properly generate the step-by-step instructions.

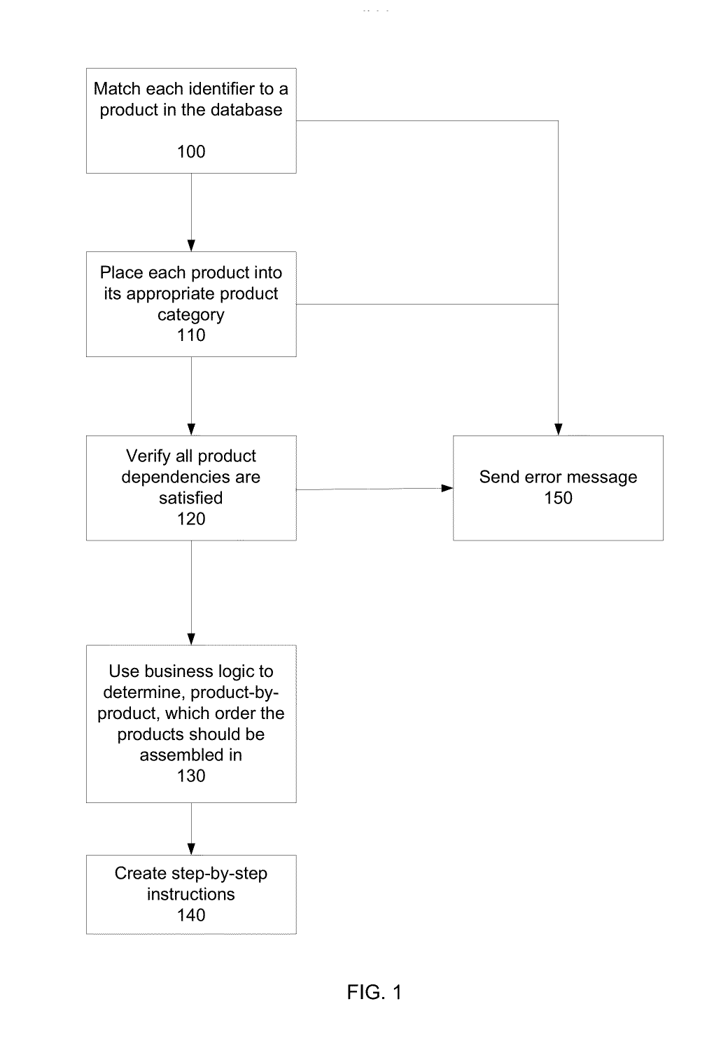

FIG. 1 shows a flowchart of this portion of the process. In step 100, a product identifier is presented to the system 10, such as by the methods described above using the input system 20. The database 30 contains a list of components, each having various attributes, including a product category. In step 100, the system 10 verifies that the product indicated by the product identifier, is in the database 30. If it is not, an error message is sent to the output system 50, such as the user's mobile device, as shown in step 150. If the product is in the database 30, the system 10 checks if it assigned a product category, in step 110. Again, if a product category is not assigned, an error message is sent to the output system 50. This is repeated for each product that was entered by the user. If all products have been assigned a product category, the system moves to step 120, where product dependencies are tested. This step 120 insures that various dependencies are met. For example, the existence of component A may require the existence of component B. If component A is entered, but component B is not present, this check may fail, resulting in an error message being sent to the output system 50. If all dependencies are satisfied, the process moves to step 130 where it uses rules-based logic to determine product-by-product, which order the products should be assembled in. Once it has determined the next instruction step in the assembly, pictures or other illustrations may be added to the instructions.

As explained above, all of this component specific information is forwarded to the controller 40, or rules-based logic system. This logic system 40 first performs a test for compatibility, using a set of rules. Some of these rules may be those enumerated above, such as proper configuration of components, proper connectors and cables, compatible input and output specifications, and others.

Once these checks have been performed, the rules-based logic system 40 generates a set of step-by-step instructions, using various rules. For example, a rule may indicate that an active subwoofer should be connected before passive speakers. Once the controller 40 determines a particular rule to be utilized, it may extract images to use. For example, if the controller 40 determines that connecting the subwoofer is the next instruction step, it will create an instruction showing an image of the back of the power amplifier, and optionally pointing or otherwise indicating the port into which the cable is to be connected. These images may be stored in the database 30, or in another storage device. The type of cable to be used will also be defined and identified. The next instruction step would then show an image of the subwoofer, optionally pointing to, or otherwise indentifying where the cable is attached on the subwoofer. As all of the products are in the database 30, the images available in the database 30 exactly match the components being assembled by the user. This process continues until all of the instruction steps have been completed.

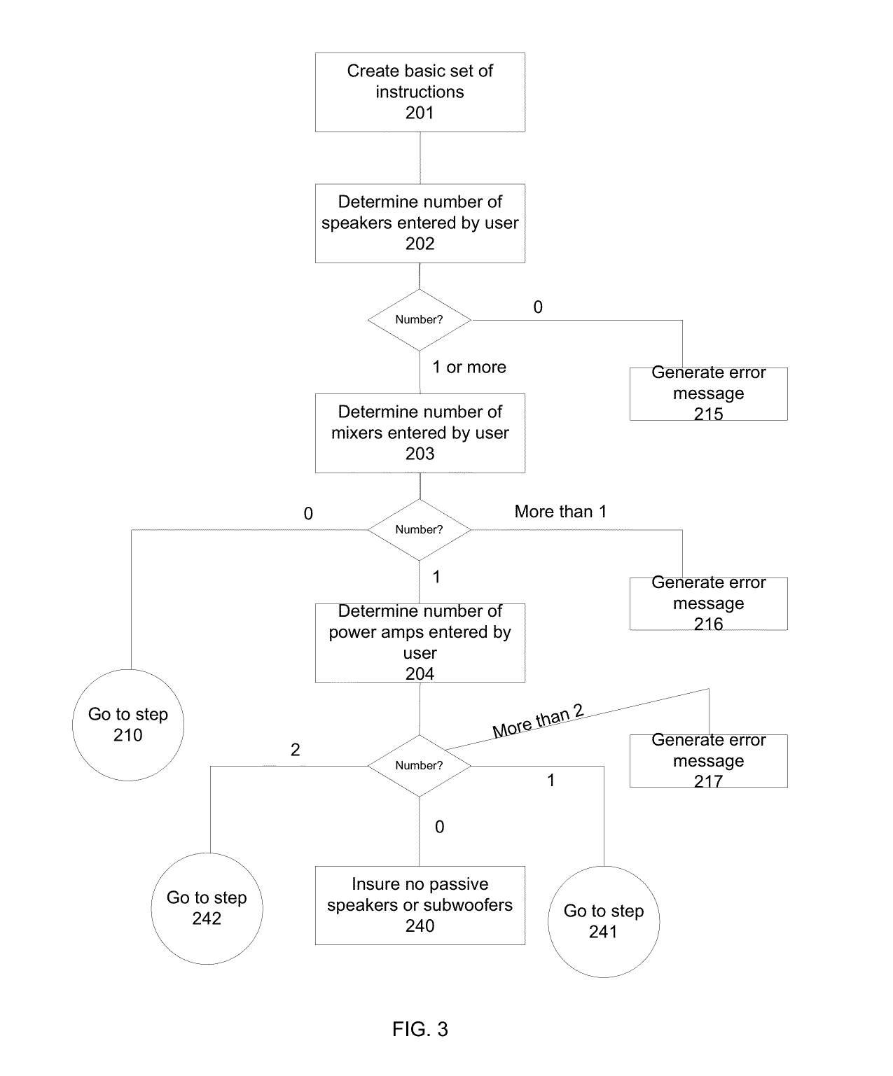

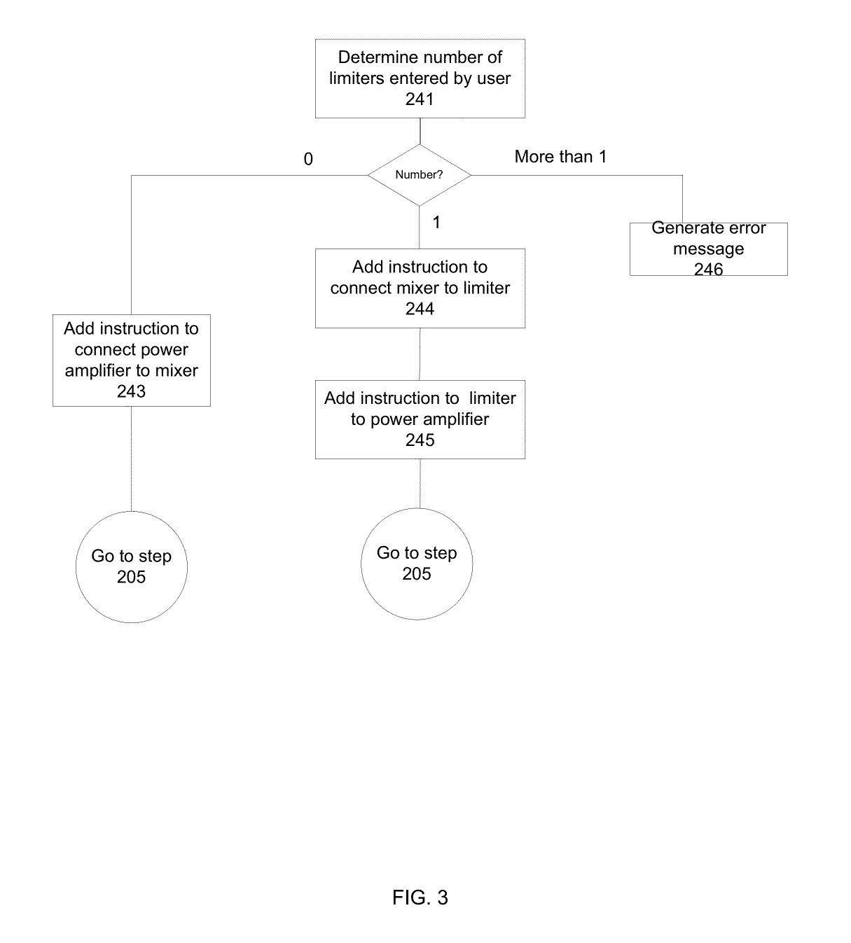

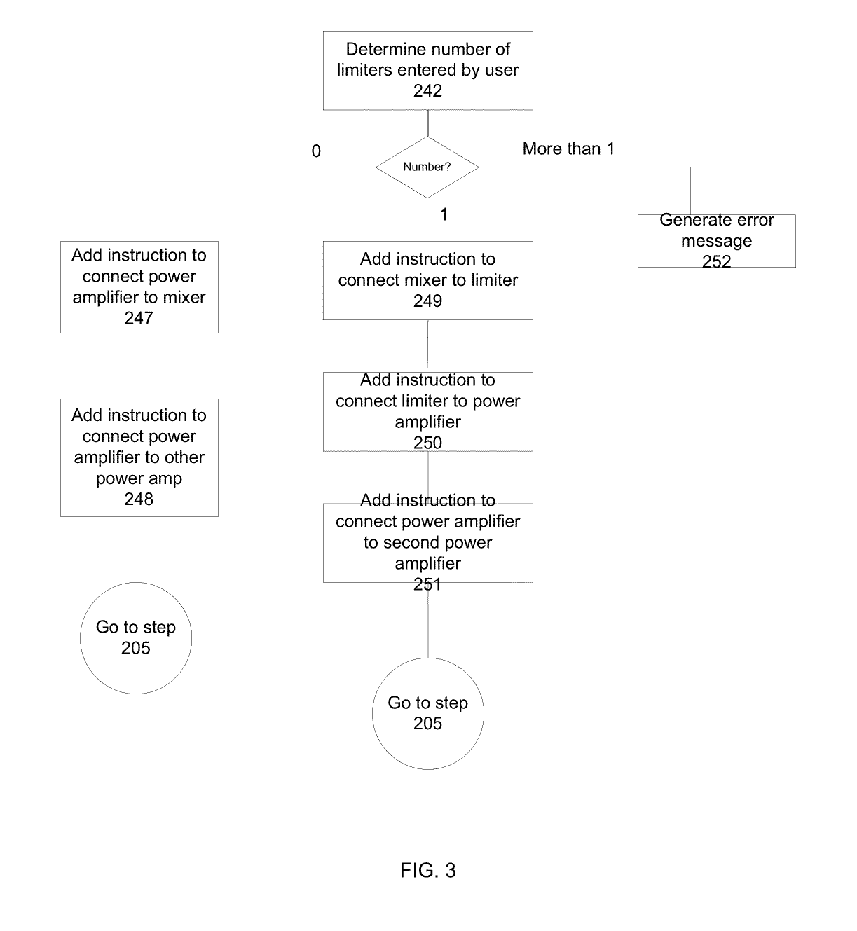

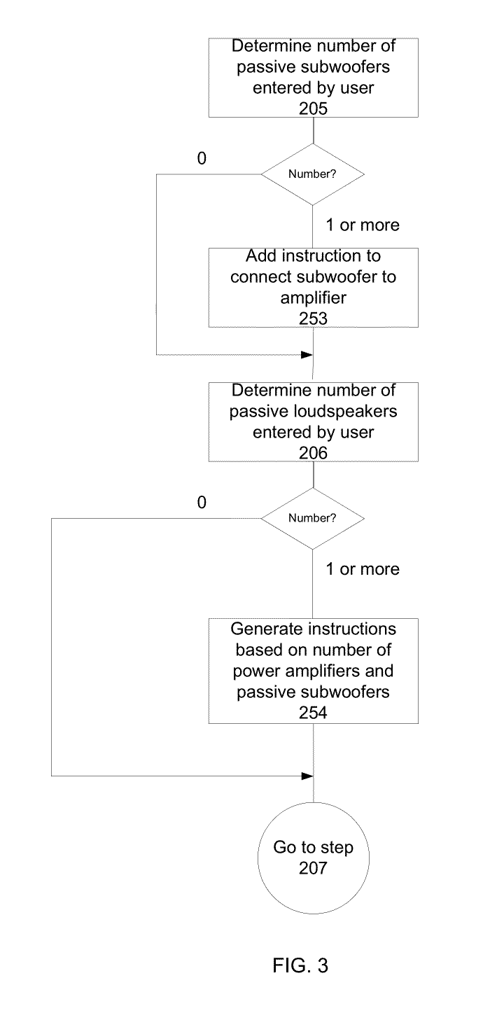

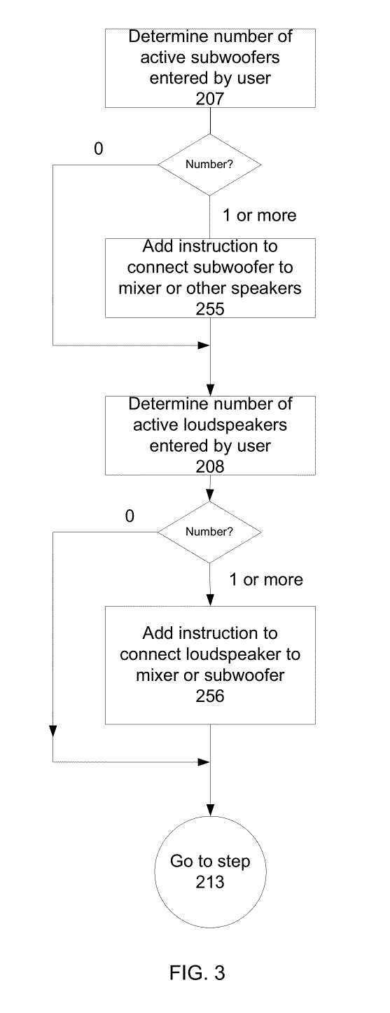

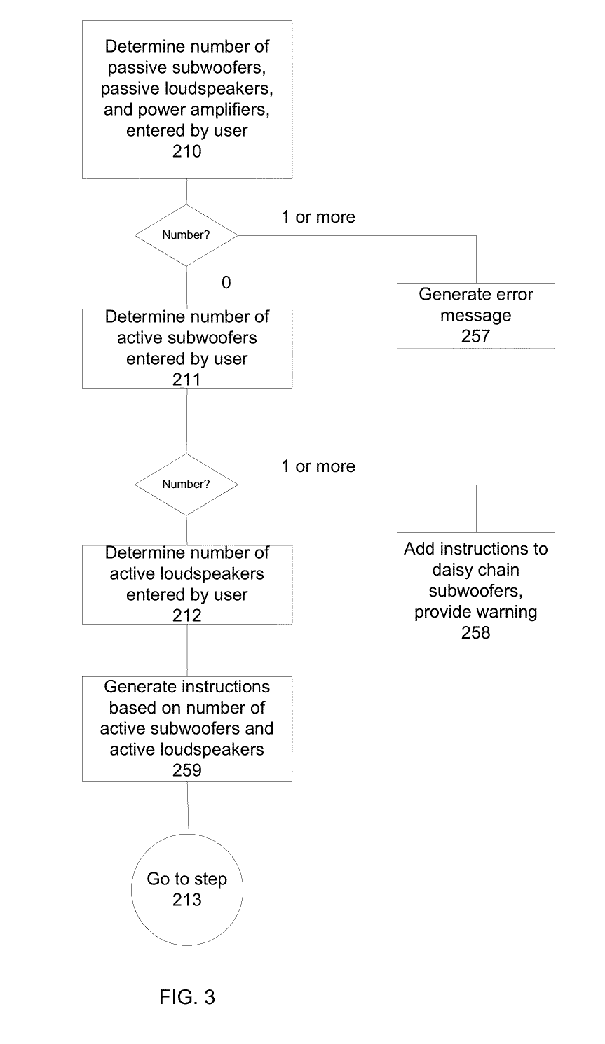

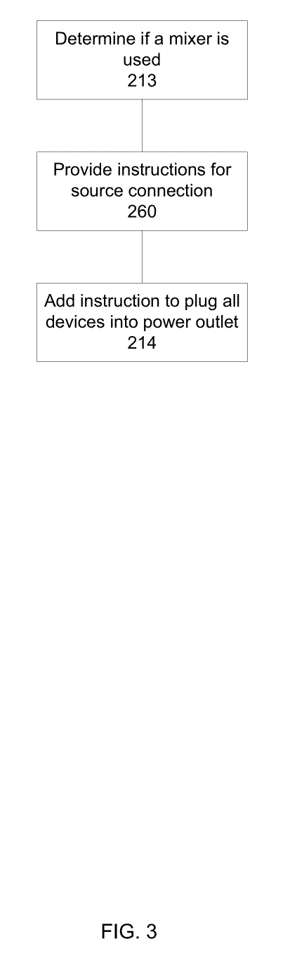

FIG. 3 shows a flowchart that illustrates one embodiment of the present invention. Of course, other embodiments using other components and other rules may also be used and the invention is not limited to any particular embodiment. As shown in step 201, in some embodiments, the first step is to create a basic set of instructions. In some embodiments, this list may comprise only one instruction: turn off all products, turn down all volume dials.

Next, in this particular embodiment, as shown in step 202, the controller 40 determines the number of active loudspeakers, active subwoofers, passive subwoofers, and passive loudspeakers that have been entered by the user using the input system 20. If there are no loudspeakers entered, an error message is sent to the user via the output system 50, stating that no speakers were entered, as shown in step 215. In this case, no more instructions are generated.

If one or more speakers was entered, the system continues on and determines the number of mixers, as shown in step 203. If more than 1 mixer has been entered, the system sends an error message to the user, indicating that too many mixers were scanned, as shown in step 216. In this case, no more instructions are generated.

If no mixers were entered by the user, the system moves to step 210, which is described in more detail below. If exactly one mixer was entered by the user via the input system 50, the system moves to step 204, where the number of power amplifiers is determined.

If there are no power amplifiers, as shown in step 240, the setup cannot have any passive subwoofers or passive loudspeakers. If any of these components were previously entered by the user, an error message is returned, indicating that the configuration is not valid. If more than 2 power amplifiers are entered by the user, an error message is returned, indicating that too many power amplifiers were entered, as shown in step 217. In other embodiments, the system may decide to daisy chain the amplifiers if the wattage from all of them is needed to power to passive speakers. Alternatively, if there are multiple speakers, the system may decide to power different speakers using different power amplifiers.

If there is one power amplifier, the system moves to step 241, where the number of limiters is determined. If there are no limiters, the system generates an instruction indicating that the power amplifier should be connected to the mixer, as shown in step 243. As described earlier, one or more images may be included with this instruction. If there is one limiter, the system generates two new instructions, telling the user to connect the mixer to the limiter, as shown in step 244, and then to connect the limiter to the power amplifier, as shown in step 245. If more than one limiter is entered by the user, the system reports an error, indicating that too many limiters were scanned, as shown in step 246.

If there are two power amplifiers, the system moves to step 242, where the number of limiters is determined. If there are no limiters, the system generates an instruction indicating that the power amplifier should be connected to the mixer, as shown in step 247. As described earlier, one or more images may be included with this instruction. It also generates an instruction indicating the first power amplifier should be connected to the second power amplifier, as shown in step 248. If there is one limiter, the system generates three new instructions, telling the user to connect the mixer to the limiter, as shown in step 249, then to connect the limiter to the power amplifier, as shown in step 250. A third instruction, shown in step 251, tells the user to connect one power amplifier to the other power amplifier.

If more than one limiter is entered by the user, the system reports an error, indicating that too many limiters were scanned, as shown in step 252.

After the process steps involving the power amplifiers have been executed, all paths continue to step 205, where the number of passive subwoofer is determined. If there are no passive subwoofers, the system continues with step 206. If there is at least one subwoofer, instructions are added, as shown in step 253. These instructions may include, for example, connecting the passive subwoofer(s) into either the low-end power amplifier or the single power amplifier in the following fashion: right, left, right, left . . . and so forth, potentially forming two chains of passive subwoofers.

Next, as shown in step 206, the number of passive loudspeakers is determined. If there are no loudspeakers, the system continues with step 207. If there are one or more passive loudspeakers, instructions are generated based on the number of power amplifiers and passive subwoofers, as shown in step 254.

For example, if there is at least one passive subwoofer AND there is only one two channel power amplifier, an error message is send to the user, indicating that another power amplifier is needed. The system may then stop generating instructions.

If there is at least one passive subwoofer AND there are two power amplifiers, additional instructions are added. For example, the instruction may include: plugging in the passive loudspeaker(s) into the high-end power amplifier in the following fashion: right, left, right, left . . . and so forth, potentially forming two chains of passive loudspeakers.

If there are no passive subwoofers AND there is only one power amplifier, instructions are added, such as plugging the passive loudspeaker(s) into the single power amplifier in the following fashion: right, left, right, left . . . and so forth, potentially forming two chains of passive loudspeakers.

If there are no passive subwoofers AND there is two power amplifiers, instructions are added. These instructions may include: plugging the passive loudspeaker(s) into the high-end power amplifier in the following fashion: right, left, right, left . . . and so forth, potentially forming two chains of passive loudspeakers. Additionally, a warning may be generated to the user, indicating that the other power amplifier is not necessary.

In step 207, the number of active subwoofers is determined. If there are no active subwoofers, the system continues with step 208. If there are one or more active subwoofers, new instructions are generated. These instructions may include, for example, plugging the active subwoofer(s) into the mixer in the following fashion: right, left, right, left . . . and so forth, potentially forming two chains of active subwoofers, as shown in step 255. In other embodiments, the active subwoofer and loudspeakers may be plugged into each other. In this way, multiple speakers may be daisy chained together.

In step 208, the number of active loudspeakers is determined. If there are no active loudspeakers, the system continues with step 209. If there are at least one loudspeaker, the system adds new instructions. For example, the instruction may include: connecting the active loudspeaker(s) into the mixer in the following fashion: right, left, right, left . . . and so forth, potentially forming two chains of chains of active loudspeakers. In some embodiments, if there were any active subwoofers in the right or left spots, then plug the first active loudspeaker into the last active subwoofer instead of the mixer.

In step 210, the number of passive subwoofers, limiters, passive loudspeakers, and power amplifiers is determined. If there are any of these components, an error message is sent to the user, as shown in step 257, indicating that a mixer is necessary for this configuration.

In step 211, the number of active subwoofers is determined. If it is less than 2, the system continues with step 212. If the number of active subwoofers is greater than 1, instructions are added to connect the subwoofers together in a chain. In addition, a warning may be added, suggesting that a mixer should be utilized with this setup, as shown in step 258. In step 212, the number of active loudspeakers is determined. Based on the number of subwoofers, new instructions are added, as shown in step 259. For example, if there are less than 2 active loudspeakers, and at least one active subwoofer, a new instruction may be added: plugging the active loudspeaker to either the single active subwoofer or the last active subwoofer in the chain. In addition, a warning that mixer should be incorporated with this setup may be sent to the user.

If there are less than 2 active loudspeakers and there were no active subwoofers, no new instructions are generated and the system proceeds to step 213.

If there is more than one active loudspeakers, the new instructions include: plugging the active loudspeakers together in a chain. If there are any active subwoofers, plug this chain into either the single active subwoofer or the last active subwoofer in the chain. In addition, a warning that a mixer should be used with this setup may be sent to the user.

In step 213, a determination is made as to whether there is a mixer. If so, instructions are added, which include: plugging the source (e.g. laptop, iPod) to the mixer, as shown in step 260. If there is no mixer, alternate instructions are generated, such as, for example, plugging the source to the first of the daisy chained speakers, which would be an active subwoofer if there is one or an active loudspeaker if there are no active subwoofers.

In step 214, instructions are added which may include: plugging all products that need to be plugged into a power source (active subwoofers, active loudspeakers, mixers, turntables, power amplifiers, limiters) into the wall.

When all of these steps of the flowchart have been completed, a complete instruction manual, unique to this configuration will have been generated. At this point, the set of instructions is then sent to the output system 50.

The above flowchart is illustrative of one set of rules. However, the invention is not limited to only this embodiment. For example, a different sequence of rules can be used, or additional rules may be added. For example, the above illustration did not include any video products, such as televisions, DVD players, or the like. Different or additional rules would be developed to accommodate these types of components. For example, a television may have a variety of inputs, including HDMI, S-Video, and composite. The rules may be written to insure that there is an input available for each video source (cable box, DVD player, DirecTV, etc). The rules may then determine which of these video sources should be connected to each input on the television.

Returning to step 140 (see FIG. 1), the step-by-step instructions may be assembled in a number of ways. In one embodiment, a pdf file is created, complete with color illustrations. This allows the user to print the instructions to paper if desired. In another embodiment, the instructions appear as a sequential set of web pages.

The use of a mobile phone as the input and output system 20, 50 may have other benefits. For example, most mobile phones have GPS capability. Thus, use of the mobile software application enables the present invention to determine the location of the user. This information can be used in a number of ways. First, in the case where the user needs to purchase another component, the present invention, based on the user's location, may suggest the nearest location where the component is available. The present invention may also target specific advertising or other information based on the user's location. Of course, this information can also be used to allow the owner of the present invention to better target advertising campaigns and other publicity events.

Of course, other embodiments are also within the scope of the invention. For example, although audio and multimedia systems are described, the present invention is applicable to any system where components from multiple sources need to be assembled together. In addition, although the use of a mobile phone is disclosed, other input and output devices may also be used. However, the ready availability of devices having cameras, and color displays, such as mobile phones and tablets, make these devices very suitable for this invention.

In summary, this embodiment generates a custom set of instructions for the user, based on the components that were entered by that user. The order of the instructions and the images that accompany those instructions may be tailored to the specific component entered by the user. This embodiment provides fully customizable instruction manuals for users, based on their unique configuration.

The embodiment described above assumed that the user had already purchased the desired components. Another embodiment of the system may be used during the sales process. For example, a rules based controller was described which identified conflicts or incompatible components. This functionality can be used when the user is selecting the components to insure compatibility.

This embodiment includes a software application, in communication with the database of components. In some embodiments, the system may be as shown in FIG. 2. As described above, the database 30 includes all of the available components, as well of the relevant specifications for each component. The input system 20 may be a website, or a smart phone application, or another input mechanism. Upon activation, the application prompts the user to enter a first desired component, such as a set of active speakers. During the first selection, the system presents the user with the complete list of possible selections available in the database 30. In other words, since this is the first component being selected, there are no constraints on the selection of this component.

In some embodiments, the system may then prompt the user to enter another desired component, such as a set of passive speakers or a subwoofer. This selection may also be unconstrained, in that all possible choices are presented to the user.

Following this selection, the system will then prompt the user to select another component, such as an amplifier. Unlike the first user selection, the selection of this component may not be unconstrained. The previous choices made by the user may render certain devices inoperable with the previously selected components. Thus, the system, using the rules based logic, will determine, and present, the user with only those components that are compatible with the previous selections. For example, if the user selected passive speakers that are rated to 500 W, the system may not allow the user to select an amplifier that can output 1000 W. Thus, the system may not display a 1000 W amplifier on the output system 50. The system may present the user with additional selections, which may be constrained by the previous selections, or may be unconstrained. In this way, all of the components selected by the user are guaranteed to work together.

In other words, this embodiment provides the user with the ability to select a compatible set of components which operate correctly together. This is done by taking input from the user, via the input system 20, processing that input using the controller 40, in conjunction with the database 30, and generating output on the output system 50, which reflects the choices that have already been made by the user.

An important part of many systems, such as audio system or home theater systems is the use of appropriate cables. In one embodiment, the system also allows the user to select the appropriate cables. In one embodiment, the system prompts the user to identify one end of the cable (microphone jack, coaxial connector, etc.). Based on this selection, the system, using the database 30 and the rules based logic 40 will identify possible connectors that can be used on the other end of the cable. The user then selects the second connector. At this point, the system will identify one or more cables that fulfill the user's requirements. In some embodiments, the system may also request additional information from the user, such as desired length or desired brand, before making a recommendation. The user then selects the desired cable. This process can be repeated for each cable required in the configuration that was selected above.

In another embodiment, after the user has configured all of the components (speakers, subwoofers, mixers, amplifiers, etc), the system identifies the required cables automatically. Using the database 30, the system is aware of the interconnect options of each component. Further, using the rules based logic 40, the system is aware of which components must connect to each other. Therefore, based on this information, the system can automatically determine the required connectors for each end of the cable and make decisions on the user's behalf. In some embodiments, after the system has determined the connectors required, the system may still prompt the user for a selection, which may be based on length, brand or cost.

The database 30 may be populated in a number of ways. For example, the owners of the system may be responsible for updating and maintaining the database 30. In another embodiment, a separate connection mechanism to the database is provided. For example, there may be a mechanism whereby one can remotely connect to the database 30. In this way, the database can be updated and maintained remotely. The use of a secure login mechanism may also allow trusted third parties to access and update the database 30. For example, a component manufacturer may be given permission to access the database 30 and enter the specifications for their various components. Various techniques for navigating within the database 30 may be provided. For example, menus, dropdown menus, dialog boxes, and other techniques may be used. In this way, the component manufacturer or supplier can enter the product group, product attributes and images, as necessary.

In one embodiments, in exchange for populating the database 30, the manufacturer or supplier may be given access to user demographics, such as most popular components, most popular pairings of components, etc.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. These other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A system for generating step-by-step assembly instructions for a plurality of components, comprising:
an input system to enter said components into said system;
a controller, comprising instructions including a plurality of rules, which, when executed, define a set of instructions based on said entered components;
a database, in communication with said controller, comprising attributes associated with each of said entered components; and
an output system to display said step-by-step instructions to a user.

2. The system of claim 1, wherein said input system comprises a visual scanning system to read a unique identifier attached to said components.

3. The system of claim 2, wherein said unique identifier is selected from the group consisting of bar codes, RFID tags, and QR codes.

4. The system of claim 1, wherein said output system comprises a visual display device.

5. The system of claim 1, wherein said input system and said output system are disposed on a mobile device.

6. The system of claim 5, further comprising a software application resident on said mobile device to enter said unique identifiers, transmit said identifiers to said controller, and display said step-by-step instruction.

7. The system of claim 1, wherein said components are selected from the group consisting of audio equipment, video equipment, and lighting equipment.

8. The system of claim 1, wherein said controller determines configuration errors based on said entered components, and reports said configuration errors to a user via said output system.

9. The system of claim 1, wherein said step-by-step instruction comprises images of said components accompanied by written instructions.

10. The system of claim 1, wherein said database is located remotely from said input system and said output system, and communications between said database and said input system and output system occur using a network connection.

11. The system of claim 10, wherein said network connection is wireless.

12. The system of claim 1, wherein said components are supplied from different manufacturers.

13. A method for generating step-by-step instructions for the assembly of a system comprising a plurality of components, comprising:
entering a unique identifier for each of said components using an input system;
determining attributes associated with each component using a controller in communication with a database;
generating step-by-step instructions based on said components and said attributes; and
outputting said step-by-step instructions to a output device.

14. The method of claim 13, wherein said unique identifier is disposed on said respective component.

15. The method of claim 13, wherein said components are selected from the group consisting of audio equipment, video equipment, and lighting equipment.

16. A method for generating step-by-step instructions for the assembly of a system comprising a plurality of components, said components are selected from the group consisting of audio equipment, video equipment, and lighting equipment, comprising:
scanning a unique identifier associated with each component using a camera on a mobile device;
determining attributes associated with each respective component using a controller in communication with a database;
generating step-by-step instructions based on said components and said attributes;
displaying said step-by-step instructions on a video display of said mobile device.

17. The method of claim 16, wherein said step-by-step instructions include images of said components.
